(19) United States
(12) Patent Application Publication
(10) Pub. No.: US 2025/0168083 A1
(43) Pub. Date: May 22, 2025

(54) BRING YOUR OWN DEVICE (BYOD) METHOD AND DEVICE

(71) Applicant: YEALINK (XIAMEN) NETWORK TECHNOLOGY CO., LTD., Xiamen (CN)

(72) Inventor: Hu Jiang, Xiamen (CN)

(21) Appl. No.: 19/031,349

(22) Filed: Jan. 18, 2025

Related U.S. Application Data
(63) Continuation-in-part of application No. PCT/CN2024/101111, filed on Jun. 25, 2024.

(30) Foreign Application Priority Data
Jul. 20, 2023 (CN) 202310899986.X

(51) Int. Cl. H04L 41/40; H04L 69/22

(52) U.S. Cl. CPC H04L 41/40; H04L 69/22

(57) ABSTRACT

Provided are a bring your own device (BYOD) method and device. The BYOD method includes: obtaining network data, where the network data includes multiplex audio data and multiplex video data; and sending the network data to a personal computer (PC) through one bulk endpoint based on a Transmission Control Protocol (TCP)/an Internet Protocol (IP), and allowing the PC to write the audio data into various virtual USB audio class (UAC) devices and the video data into various virtual USB video class (UVC) devices, respectively. The present disclosure packages and sends the network data to the PC through the one bulk endpoint based on the TCP/IP, and creates the virtual UAC device and the virtual UVC device based on the TCP/IP. This avoids enumeration of a UAC device and a UVC device using an actual USB endpoint, breaking hardware limitation and achieving strong scalability.

### CROSS-REFERENCE TO RELATED APPLICATIONS

The present application is a Continuation-In-Part Application of PCT Application No. PCT/CN2024/101111 filed on Jun. 25, 2024, which claims the benefit of Chinese Patent Application No. 202310899986.X filed on Jul. 20, 2023, the contents of which are hereby incorporated by reference.

### TECHNICAL FIELD

The present disclosure relates to the field of data communication, and in particular, to a bring your own device (BYOD) method and device.

### BACKGROUND

At present, in the bring your own device (BYOD) method, a BYOD device receives audio and video data streams from a video conference system (VCS) host through a network, and then uses a BYOD program to send a video to a USB video class (UVC) device through a bulk (bulk transfer) endpoint, and an audio to a USB audio class (UAC) device through an ISOC (synchronous transfer) endpoint. A personal computer (PC) receives video data through a UVC device enumerated by an actual bulk endpoint and plays the video data on video software of the PC. The PC receives audio data through a UAC device enumerated by an actual ISOC endpoint and plays the audio data on audio software of the PC. In this way, the PC can play the audio data and the video data of the VCS host, achieving a BYOD function.

An existing solution has implemented the BYOD function. However, in a use process, an actual USB endpoint device needs to be used for enumeration, which imposes a high requirement for a quantity of USB endpoints in a multi-stream scenario, resulting in a risk that there are not sufficient hardware endpoints.

### SUMMARY

The present disclosure provides a BYOD method and device, to solve technical problems of a limited quantity of devices and a high hardware requirement caused by enumerating a UAC/UVC device through an actual USB endpoint in an existing solution.

To solve the above technical problems, the present disclosure provides a BYOD method, including:

obtaining network data, where the network data includes multiplex audio data and multiplex video data; and

sending the network data to a PC through one bulk endpoint based on a network protocol, and allowing the PC to write the audio data into various virtual UAC devices and the video data into various virtual UVC devices, respectively.

The present disclosure packages and sends the network data to the PC through the one bulk endpoint based on the network protocol, and creates the virtual UAC device and the virtual UVC device based on the network protocol. This avoids enumeration of a UAC device and a UVC device by an actual USB endpoint, thereby breaking a hardware limitation and achieving strong scalability. In addition, the audio data and the video data do not need to be separated when being transmitted to the PC, thereby simplifying a data transmission process and improving data transmission efficiency.

Further, the allowing the PC to write the audio data into various virtual UAC devices and the video data into various virtual UVC devices, respectively specifically includes:
parsing the network data to obtain a quantity of the audio data and a quantity of the video data;
based on the network protocol, creating a corresponding quantity of virtual UAC devices based on the quantity of the audio data, and creating a corresponding quantity of virtual UVC devices based on the quantity of the video data; and
writing the audio data into the virtual UAC devices and the video data into the virtual UVC devices, respectively.

The present disclosure creates the corresponding quantity of virtual UAC devices for the quantity of the audio data and the corresponding quantity of UVC devices for the quantity of the video data based on the network protocol, without a need to enumerate the UAC device and the UVC device by the actual USB endpoint. This breaks the hardware limitation and improves scalability.

Further, the obtaining network data specifically includes:
receiving the network data through a wired or wireless network card.

In the present disclosure, the network data is received through the wired or wireless network card, and the network data is transmitted to the PC based on the network protocol. The two data transmissions have a same format. Therefore, when the network data is received, the audio data and the video data in the network data do not need to be separated, and can be merged into one bulk port for transmission. This simplifies the data transmission process and improves the data transmission efficiency.

Further, after the writing the audio data into the virtual UAC devices and the video data into the virtual UVC devices, respectively, the BYOD method further includes:
starting all the virtual UAC devices and all the virtual UVC devices through audio software and video software of the PC respectively; and
simultaneously playing the audio data and the video data in all the virtual UAC devices and all the virtual UVC devices.

According to a second aspect, the present disclosure further provides a BYOD device, including a data obtaining module and a data forwarding module, where
the data obtaining module is configured to obtain network data, where the network data includes multiplex audio data and multiplex video data; and
the data forwarding module is configured to send the network data to a PC through one bulk endpoint based on a network protocol, and allow the PC to write the audio data into various virtual UAC devices and the video data into various virtual UVC devices, respectively.

Further, the data forwarding module is specifically configured to:
parse the network data to obtain a quantity of the audio data and a quantity of the video data;
based on a Transmission Control Protocol (TCP)/an Internet Protocol (IP), create a corresponding quantity of virtual UAC devices based on the quantity of the audio data, and create a corresponding quantity of virtual UVC devices based on the quantity of the video data; and

write the audio data into the virtual UAC devices and the video data into the virtual UVC devices, respectively.

Further, the data obtaining module is specifically configured to:
receive the network data through a wired or wireless network card.

Further, the data forwarding module is further configured to:
start all the virtual UAC devices and all the virtual UVC devices through audio software and video software of the PC respectively; and
simultaneously play the audio data and the video data in all the virtual UAC devices and all the virtual UVC devices.

According to a third aspect, the present disclosure further provides a computer device, including a processor, a communication interface, and a memory, where the processor, the communication interface, and the memory are connected to each other, the memory is configured to store executable program code, and the processor is configured to invoke the executable program code to execute the BYOD method.

According to a fourth aspect, the present disclosure further provides a computer-readable storage medium, where the computer-readable storage medium stores a computer instruction, and the computer instruction is executed by a processor to implement the BYOD method.

### BRIEF DESCRIPTION OF DRAWINGS

FIG. 1 is a schematic flowchart of a BYOD method according to an embodiment of the present disclosure;

FIG. 2 is a schematic diagram of data transmission in a BYOD method according to an embodiment of the present disclosure; and

FIG. 3 is a schematic structural diagram of a BYOD device according to an embodiment of the present disclosure.

### DETAILED DESCRIPTION

The technical solutions of the embodiments of the present disclosure are clearly and completely described below with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

### Embodiment 1

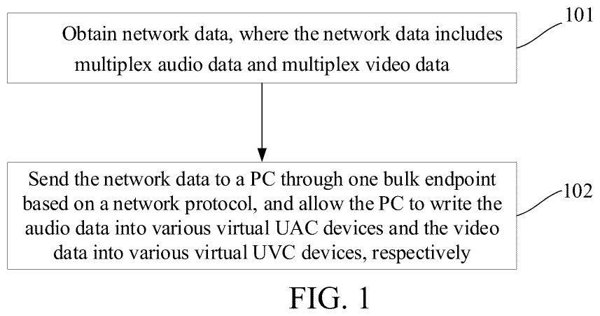

FIG. 1 is a schematic flowchart of a BYOD method according to an embodiment of the present disclosure. Referring to FIG. 1, the BYOD method specifically includes following steps 101 and 102:

Step 101: Obtain network data, where the network data includes multiplex audio data and multiplex video data.

In this embodiment, the obtaining network data specifically includes:
receiving the network data through a wired or wireless network card.

In this embodiment, through the wired or wireless network card, a BYOD device obtains the network data sent by a VCS host.

In this embodiment, the VCS host collects the video data and the audio data, encodes and packages the video data through video encoding and decoding such as H.264, encodes and packages the audio data through an audio codec such as AAC, and sends encoded and packaged video data and audio data to the BYOD device through a network.

In this embodiment, the network data is received through the wired or wireless network card, and the network data is transmitted to a PC based on a network protocol. The two data transmissions have a same format. Therefore, when the network data is received, the audio data and the video data in the network data do not need to be separated, and can be merged into one bulk port for transmission. This simplifies a data transmission process and improves data transmission efficiency.

Step 102: Send the network data to the PC through one bulk endpoint based on the network protocol, and allow the PC to write the audio data into various virtual UAC devices and the video data into various virtual UVC devices, respectively.

In this embodiment, the network protocol includes but is not limited to a TCP/an IP, an Internet Packet eXchange (IPX) protocol/a Sequenced Packet Exchange (SPX) protocol, and a NetBios Enhanced User Interface (NetBEUI) protocol.

In this embodiment, the TCP/IP is taken as an example for description. As a reliable transmission protocol, the TCP/IP has a retransmission mechanism. When the audio data and the video data are transmitted, reliability of the protocol itself can be relied on to improve packet loss resistance of data transmission, thereby improving fault tolerance of the BYOD method and enhancing user experience.

In this embodiment, since a format of the audio data transmitted by the BYOD device and a format of the audio data transmitted by the TCP/IP of the PC are the same, the BYOD device only needs to forward the network data after receiving the network data. The BYOD device does not need to decode the network data or transmit audio and video streams through two ports. Instead, the network data can be transmitted through one bulk port.

In this embodiment, the allowing the PC to write the audio data into the virtual UAC devices and the video data into the virtual UVC devices, respectively specifically includes:
parsing the network data to obtain a quantity of the audio data and a quantity of the video data;
based on the network protocol, creating a corresponding quantity of virtual UAC devices based on the quantity of the audio data, and creating a corresponding quantity of virtual UVC devices based on the quantity of the video data; and
writing the audio data into the virtual UAC devices and the video data into the virtual UVC devices, respectively.

In this embodiment, the BYOD device forwards the network data to the PC through the one bulk endpoint based on the TCP/IP. The PC receives the network data based on the TCP/IP and decodes the network data to obtain the quantity of the audio data and the quantity of the video data. Based on the TCP/IP, the corresponding virtual UAC devices are created for the quantity of the audio data and the corresponding virtual UVC devices are created for the quantity of the video data.

In this embodiment, the BOYD device sends data based on the TCP/IP. The network data is still transmitted through a USB interface by a USB over IP technology, that is, the USB interface supports data transmission by the TCP/IP.

In this embodiment, based on the TCP/IP, the corresponding virtual UAC devices are created for the quantity of the audio data and the corresponding virtual UVC devices are created for the quantity of the video data, without a need to enumerate a UAC device and a UVC device by an actual USB endpoint. This breaks a hardware limitation and improves scalability.

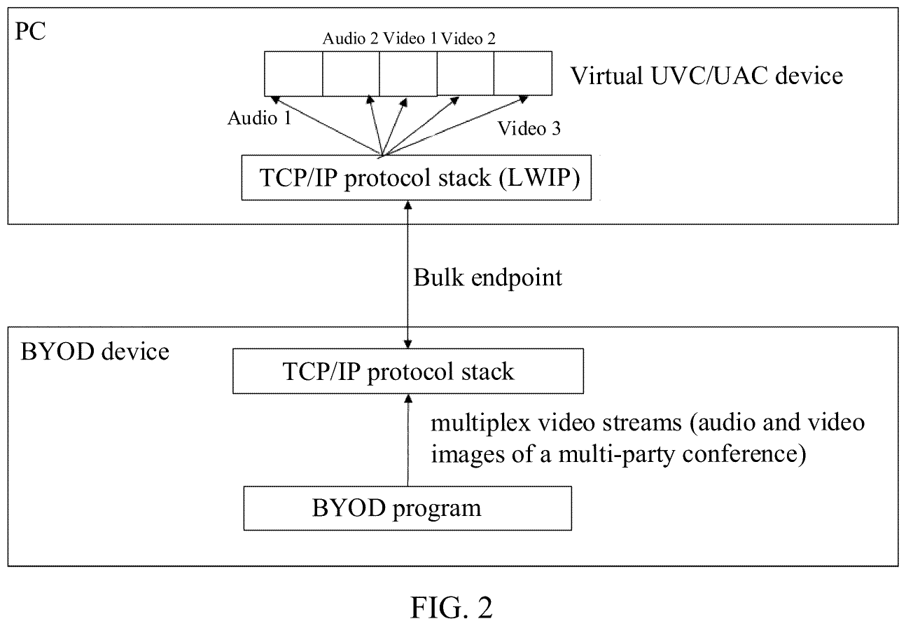

FIG. 2 is a schematic diagram of data transmission in a BYOD method according to an embodiment of the present disclosure.

In this embodiment, a TCP/IP protocol stack is built-in on both the PC and the BYOD device, which may be a lightweight IP (LWIP) protocol stack and can run with or without support from an operating system. Main functions of the TCP are maintained through an LWIP to reduce occupation of a random access memory (RAM). The LWIP only requires a RAM of a dozen of KB and a read-only memory (RAM) of around 40K to run, and therefore can be used in a low-end embedded system.

In this embodiment, the BYOD device obtains, through the wired or wireless network card, the audio data and the video data sent by the VCS host, and then sends the audio data and the video data to the PC through a BYOD program based on the TCP/IP. The BYOD program is software built in the BYOD device, and used to transmit the received audio data and video data.

In this embodiment, based on the TCP/IP, the audio data is written into the virtual UAC devices in a one-to-one manner, and the video data is written into the virtual UVC devices in a one-to-one manner.

In this embodiment, after the writing the audio data into the virtual UAC devices and the video data into the virtual UVC devices, respectively, the BYOD method further includes:
starting all the virtual UAC devices and all the virtual UVC devices through audio software and video software of the PC respectively; and
simultaneously playing the audio data and the video data in all the virtual UAC devices and all the virtual UVC devices.

In this embodiment, the audio software of the PC starts the virtual UAC device and plays the received audio data. The video software of the PC starts the virtual UVC device and plays the received video data. Audio and video calls can be achieved among a plurality of persons through synchronous playing.

In this embodiment, the present disclosure packages and sends the network data to the PC through the one bulk endpoint based on the TCP/IP, and creates the virtual UAC device and the virtual UVC device based on the TCP/IP. This avoids the enumeration of the UAC device and the UVC device by the actual USB endpoint, thereby breaking the hardware limitation and achieving strong scalability. In addition, the audio data and the video data do not need to be separated when being transmitted to the PC, thereby simplifying the data transmission process and improving the data transmission efficiency.

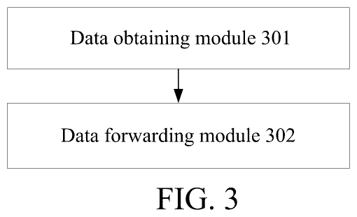

FIG. 3 is a schematic structural diagram of a BYOD device according to an embodiment of the present disclosure. Referring to FIG. 3, the BYOD device includes a data obtaining module 301 and a data forwarding module 302.

The data obtaining module 301 is configured to obtain network data, where the network data includes multiplex audio data and multiplex video data.

The data forwarding module 302 is configured to send the network data to a PC through one bulk endpoint based on a network protocol, and allow the PC to write the audio data into various virtual UAC devices and the video data into various virtual UVC devices, respectively.

In this embodiment, the data forwarding module 302 is specifically configured to:
parse the network data to obtain a quantity of the audio data and a quantity of the video data;
based on the network protocol, create a corresponding quantity of virtual UAC devices based on the quantity of the audio data, and create a corresponding quantity of virtual UVC devices based on the quantity of the video data; and
write the audio data into the virtual UAC devices and the video data into the virtual UVC devices, respectively.

In this embodiment, the data obtaining module 301 is specifically configured to:

receive the network data through a wired or wireless network card.

In this embodiment, the data forwarding module 302 is further configured to:
start all the virtual UAC devices and all the virtual UVC devices through audio software and video software of the PC respectively; and
simultaneously play the audio data and the video data in all the virtual UAC devices and all the virtual UVC devices.

In another implementation example, the BYOD device includes a processor. The processor is configured to execute the foregoing program modules stored in a memory, including the data obtaining module 301 and the data forwarding module 302.

The embodiments of the present disclosure further provide a computer device, including a processor, a communication interface, and a memory. The processor, the communication interface, and the memory are connected to each other. The memory is configured to store executable program code, and the processor is configured to invoke the executable program code to execute the BYOD method.

The embodiments of the present disclosure further provide a computer-readable storage medium. The computer-readable storage medium stores a computer instruction, and the computer instruction is executed by a processor to implement the BYOD method.

In the embodiments, the network data is packaged and sent to the PC through the one bulk endpoint based on the network protocol, and the virtual UAC device and the virtual UVC device are created based on the network protocol. This avoids the enumeration of the UAC device and the UVC device by the actual USB endpoint, thereby breaking the hardware limitation and achieving the strong scalability. In addition, the audio data and the video data do not need to be separated when being transmitted to the PC, thereby simplifying the data transmission process and improving the data transmission efficiency.

The objectives, technical solutions, and beneficial effects of the present disclosure are further described in detail through the above specific embodiments. It should be understood that the above are merely some specific embodiments of the present disclosure, but are not intended to limit the protection scope of the present disclosure. It should be particularly noted that, any modifications, equivalent substitutions, improvements, and the like made by those skilled in the art within the spirit and principle of the present disclosure should be included within the protection scope of the present disclosure.

1. A bring your own device (BYOD) method, comprising:
obtaining network data, wherein the network data comprises multiplex audio data and multiplex video data; and
sending the network data to a personal computer (PC) through one bulk endpoint based on a network protocol, and allowing the PC to write the audio data into various virtual USB audio class (UAC) devices and the video data into various virtual USB video class (UVC) devices, respectively.

2. The BYOD method according to claim 1, wherein the allowing the PC to write the audio data into various virtual UAC devices and the video data into various virtual UVC devices, respectively specifically comprises:
parsing the network data to obtain a quantity of the audio data and a quantity of the video data;
based on the network protocol, creating a corresponding quantity of virtual UAC devices based on the quantity of the audio data, and creating a corresponding quantity of virtual UVC devices based on the quantity of the video data; and
writing the audio data into the virtual UAC devices and the video data into the virtual UVC devices, respectively.

3. The BYOD method according to claim 1, wherein the obtaining network data specifically comprises:
receiving the network data through a wired or wireless network card.

4. The BYOD method according to claim 2, wherein after the writing the audio data into the virtual UAC devices and the video data into the virtual UVC devices, respectively, the BYOD method further comprises:
starting all the virtual UAC devices and all the virtual UVC devices through audio software and video software of the PC respectively; and
simultaneously playing the audio data and the video data in all the virtual UAC devices and all the virtual UVC devices.

5. A BYOD device, comprising a data obtaining module and a data forwarding module, wherein
the data obtaining module is configured to obtain network data, wherein the network data comprises multiplex audio data and multiplex video data; and
the data forwarding module is configured to send the network data to a PC through one bulk endpoint based on a network protocol, and allow the PC to write the audio data into various virtual UAC devices and the video data into various virtual UVC devices, respectively.

6. The BYOD device according to claim 5, wherein the data forwarding module is specifically configured to:
parse the network data to obtain a quantity of the audio data and a quantity of the video data;
based on the network protocol, create a corresponding quantity of virtual UAC devices based on the quantity of the audio data, and create a corresponding quantity of virtual UVC devices based on the quantity of the video data; and
write the audio data into the virtual UAC devices and the video data into the virtual UVC devices, respectively.

7. The BYOD device according to claim 5, wherein the data obtaining module is specifically configured to:
receive the network data through a wired or wireless network card.

8. The BYOD device according to claim 6, wherein the data forwarding module is further configured to:
start all the virtual UAC devices and all the virtual UVC devices through audio software and video software of the PC respectively; and
simultaneously play the audio data and the video data in all the virtual UAC devices and all the virtual UVC devices.

9. A computer device, comprising a processor, a communication interface, and a memory, wherein the processor, the communication interface, and the memory are connected to each other, the memory is configured to store executable program code, and the processor is configured to invoke the executable program code to execute the BYOD method according to claim 1.

10. A computer-readable storage medium, wherein the computer-readable storage medium stores a computer instruction, and the computer instruction is executed by a processor to implement the BYOD method according to claim 1.

11. A computer device, comprising a processor, a communication interface, and a memory, wherein the processor, the communication interface, and the memory are connected to each other, the memory is configured to store executable program code, and the processor is configured to invoke the executable program code to execute the BYOD method according to claim 2.

12. A computer device, comprising a processor, a communication interface, and a memory, wherein the processor, the communication interface, and the memory are connected to each other, the memory is configured to store executable program code, and the processor is configured to invoke the executable program code to execute the BYOD method according to claim 3.

13. A computer device, comprising a processor, a communication interface, and a memory, wherein the processor, the communication interface, and the memory are connected to each other, the memory is configured to store executable program code, and the processor is configured to invoke the executable program code to execute the BYOD method according to claim 4.

14. A computer-readable storage medium, wherein the computer-readable storage medium stores a computer instruction, and the computer instruction is executed by a processor to implement the BYOD method according to claim 2.

15. A computer-readable storage medium, wherein the computer-readable storage medium stores a computer instruction, and the computer instruction is executed by a processor to implement the BYOD method according to claim 3.
